(19) United States
(12) Patent Application Publication
(10) Pub. No.: US 2005/0030363 A1
(43) Pub. Date: Feb. 10, 2005

(54) Ink jet recording medium

(76) Inventors: Leke De Vries, Kaatsheuvel (NL); Bernadette Catharina A.M. van de Velden-Schuermans, Udenhout (NL)

Correspondence Address: MERCHANT & GOULD PC, P.O. BOX 2903, MINNEAPOLIS, MN, 55402-0903, US

(21) Appl. No.: 10/465,947

(22) PCT Filed: Dec. 27, 2001
(86) PCT No.: PCT/NL01/00944

(30) Foreign Application Priority Data
Dec. 28, 2000 (EP) 00204778.5

(51) Int. Cl. B41J 3/407

(52) U.S. Cl. 347/106

(57) ABSTRACT

The invention is directed to an ink jet recording medium comprising: —a support, and—a microporous film adhered to said support, said microporous film being an oriented polyolefin film comprising fillers and having interconnecting channels between the pores, with a void volume between 30 to 90 volume percent of the total microporous film, said microporous film has been impregnated with an aqueous solution comprising at least a water-soluble polymer and surfactant, —at least one ink receiving layer coated on said pre-treated microporous film, and—optionally, a protective layer on top of the ink receiving layer.

### FIELD OF INVENTION

The present invention relates generally to an ink jet recording medium, preferably of photographic quality, that has excellent ink absorption speed, good wettability characteristics and a good image printing quality.

### BACKGROUND OF THE INVENTION

There are in general two approaches for producing ink jet recording media with photographic quality. Both approaches have unresolved deficiencies and problems.

The conventional approach, the so called “non-microporous film type” ink jet media, is proposed in several patent publications such as DE-A 4822178, EP-A0806299, JP 2276670, and JP 5024836.

For this type of ink jet recording medium, at least one ink receptive layer is coated on a support such as a paper or a transparent film. The ink receptive layer typically contains various proportions of water soluble binders and fillers. The proportions of these components affect the properties of the coatings e.g. ink absorption properties and the gloss quality appearance of the ink jet media.

One of the important properties of an ink jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus obvious that both the binder and the filler should have a significant ability to absorb the ink solvent.

Another important property for an ink jet recording medium having photographic quality, is its glossiness. It has been a research theme for more than 10 years to find a good balance between a high ink solvent absorptivity and at the same time a high gloss value for an ink jet media.

In WO-A 0/02734 it has been described that the gloss and the permeability properties of the ink receptive coating depend very much on the concentration of the filler volume. Relatively glossy coatings can be achieved when the filler volume is small. This can be realised by choosing relatively small filler particles compared to the coating thickness. However, unless the binder is very hygroscopic, such a coating will be relatively impermeable to ink-solvent. This will result in a long drying time for the ink-solvent. And in some cases, it will lead to an unacceptable smudge problem.

In order to increase the ink-solvent absorbtivity, it is suggested among others in EP-A 0634287, JP 08282088, JP 08/290,654, and JP 2000-108501, to coat multiple layers on the support. The first coating layer formed directly on the surface of the support is designed to have a high solvent absorbtivity. The ink receptive layer that is coated as a second layer on top of the first layer, is responsible for a good gloss and colour density. In this design, there are more variables that can be utilised for adjusting the balance between the gloss and ink-solvent absorptivity properties, e.g. the ratio of binder and filler in the ink-receptive layer which in general is lower than that in the layer below; different filler particles and a different filler size for both layers.

Although a significant improvement is seen in the absorbtivity and the gloss appearance, this concept has a major disadvantage in the manufacturing process thereof. The process for manufacturing a multiple coating of filler and binder mixtures on a support is relatively slow. It is believed that the combination of an increase in the coating load and the process to coat the multiple layers containing a large amount of binder and filler particles, have significantly caused the slow manufacturing process.

Recently, a lot of investigations has been directed to the field of ink jet recording media, wherein a hygroscopic microporous membrane is involved. This so called “microporous film type” is superior to the non-microporous type especially due to its high absorption speed for the ink-solvent. By this method the drying time for the ink solvent decreases significantly. U.S. Pat. No. 4,861,644, U.S. Pat. No. 5,605,750, WO-A 9907558 and EP-A 0995611 provide some examples of the methods.

In this microporous type, the microporous film has the primary function to absorb the ink solvent. The typical microporous film suitable for this purpose is described among others in U.S. Pat. No. 4,838,172 and commercially available under the name TESLIN®. The major part of the microporous film comprises precipitated silica particles, which is suitable for absorbing the ink solvent. The hydrophilic microporous films, which are commonly used for filtration purposes are also suitable to be used for the ink solvent absorbing layer.

In U.S. Pat. No. 5,605,750 it is suggested to apply an ink receiving layer on top of the microporous membrane in order to increase the color density, glossiness, etc. The coating solution applied in this publication remains on the surface of the microporous film and does not penetrate into the pores of the microporous film.

U.S. Pat. No. 6,020,058 describes an ink material wherein on top of the microporous film, a coating solution is coated. This coated solution will stay on the surface in order to enhance the printed image quality with high color fidelity (dry thickness of this layer is around 20 μm). The coating will thus not penetrate into the pores of the microporous film, since it is not meant as an impregnating agent.

One of the disadvantages of these known microporous membranes are their price, which is relatively high. Besides that, the commercially available film has a minimum thickness of 150 μm, which is too thick to be readily laminated onto a base paper support. Hence, it would be necessary to adjust the thickness of the regular photographic base paper support or adjust the process conditions as such that we still be able to produce the photographic ink jet media according to the determined quality standard. Either way, the above mentioned adjustments to existing lamination processes is undesired and economically not favourable.

There are a lot of other microporous films with a comparable void volume which are significantly thinner (thickness less than 150 μm) and cheaper than the said hydrophilic microporous film. In WO-A 9619346, BE-A 1012087, EP-A 0283200 and U.S. Pat. No. 4,350,655 some examples thereof have been described. There microporous films are usually applied in the products that have a limited use and for disposable goods. Examples of such products include medically related products such as surgical drapes and gowns, disposable personal care absorbent products such as diapers and sanitary napkins, protective clothing, sport wears and the like.

The pore structure of said films is permeable for gas, but these films are typically water repellent. It is believed that the water repellent property of these films is caused by the polyolefin resin content of the films which is hydrophobic and the manufacturing method which involving treatment of the filler particles with fatty acids salts, silicone oils or with silanes. The filler particles, which are usually calcium carbonate that is white and low in price, need to be treated in order to make the filler hydrophobic and to obtain a polymer loading amount which is preferably higher than 65 wt %.

There remains a need for having a film that is suitable to be used as an ink solvent absorbing layer for the ink jet media, which properties are a combination of both said microporous films, i.e. a film that is thin enough, has enough void volume, has high ability to absorb the ink solvent and is cheap.

Particularly, there remains a need to have coating solutions that can be applied to various microporous films, which have a thickness of less than 150 μm and which are low in price, in order to maximise its absorption capacity towards an ink-jet ink solvent.

### SUMMARY OF THE INVENTION

The object of the present invention is to provide an ink jet recording medium comprising a microporous film, said recording medium having advantageous properties in relation to ink absorption speed, wettability characteristics and a image printing quality, more in particular being suited to produce images of photographic quality.

Accordingly the present invention provides an ink jet recording media comprising:
(i) a support, and
(ii) a microporous film adhered to said support, said microporous film being an oriented polyolefin film comprising fillers and having interconnecting channels between the pores, with a void volume between 30 to 90 volume percent of the total microporous film, said microporous film has been impregnated with an aqueous solution comprising at least a water-soluble polymer and surfactant,
(iii) at least one ink receiving layer coated on said impregnated microporous film
(iv) optionally, a protective layer on top of the ink receiving layer.

### BRIEF DESCRIPTION OF THE DRAWING

FIG. 1 is a cross sectional view of one of the embodiments of the invention.

FIG. 2 is another cross-sectional view of the embodiments of the inventions.

FIG. 3 is a schematic representation of a plot of surface tension versus the logarithmic value of the surfactant concentration in a water-soluble polymers.

### DETAILED DESCRIPTION

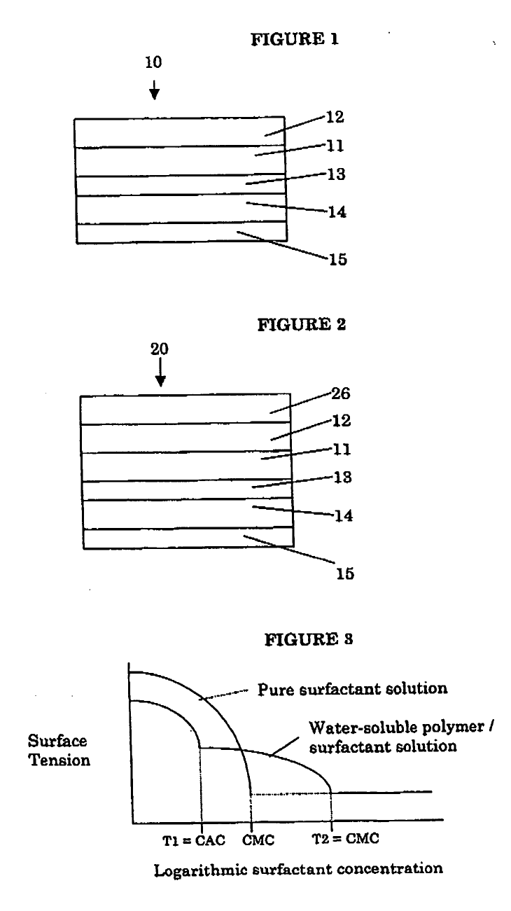

FIG. 1 illustrates one of the embodiments of the invention. Ink jet recording medium 10 comprises of a pre-treated microporous film 11. The microporous film is laminated to a support 14 by means of an adhesive layer 13. Therefore coating and laminating techniques can be applied which are known to those skilled in the art. Non limiting example of such a process is coating the adhesive layer 14 on the support by using a bar coating, gravure coating, roil coating, curtain coating, spray coating, extrusion coating or the like and adhere said microporous film 11 thereon. Thereafter, the aqueous pre-treatment solution is coated on the microporous film prior to coating the ink receiving layer 12. It is still within the spirit of this invention to apply both the pre-treatment aqueous solution and the ink receiving layer 12 at the same time by using one of the multi layers coating methods known to those skilled in the art. It is also in the spirit of the invention to pre-treat the microporous film with said aqueous solution prior to laminate said film on the support.

The microporous layer 11 can be of any porous films produced by the processes involving mixing of thermoplastic polymer with at least one filler, extruding the mixture at an elevated temperature to form a film, optionally pre-stretching the film, cooling the pre-stretched film to solidified the film and stretching the solidified film to form a microporous film. The thickness of the microporous film should be less than 150 μm, preferably between 16 and 150 μm, more preferably between 35 and 100 μm.

Minor amounts, usually less than 15 percent by weight, of other materials may optionally be present in the microporous film. Examples of such materials include matting agents such as titanium dioxide; optical brightener; surfactants; pH controllers, antioxidants, ultraviolet light absorbers, dyes, antistatic agent and the like.

The said microporous film is permeable to gas and is water repellent. Due to its water-repellent properties, it does not have enough absorption speed towards water. Hence, we need to pre-treat said microporous film by a hydrophilic coating solution.

Surprisingly, it has been found that the absorption speed of the microporous film can be increased significantly by applying a coating solution comprising a water-soluble polymer and the appropriate surfactant at a certain concentration.

Without being bound with it, it is believed that pre-treatment of the microporous film with an aqueous solution comprising only a water-soluble polymer will result in a thin film formation on the microporous film. Consequently, a water drop applied on the pre-treated microporous film will not be absorbed into the pores. On the other hand, a coating solution comprising surfactant only will penetrate into the pores and the surfactant molecules will mainly remain in the voids after drying. As consequence, the surface of the microporous film will stay hydrophobic. Pre-treatment of the microporous film by a coating solution containing water-soluble polymer and surfactant thus results in impregnation of said film.

The suitable concentration of the surfactant depends on the amount and kind of the water-soluble polymers. In order to indicate the suitable concentration meant in this invention, we firstly define the terminology critical aggregation concentration (CAC), critical micelle concentration (CMC) and the meaning of those concentration region in a water-soluble polymer/surfactant mixture.

FIG. 3 shows a schematic representation of a plot of surface tension versus the logarithmic value of the surfactant concentration, illustrating the position of the transition points. The labelling of these two transition points, T1 and T2, was introduced by M. N. Jones, in “Journals of Colloid and Interfacial Science” number 23 (1967), page 36, in his studies of sodium dodecyl sulphate (SDS) and poly-ethylene-oxide. This is in contrast with aqueous surfactant solution where only one break point at the critical micellization concentration (CMC) is observed. In the article titled Anionic Surfactants; Physical chemistry of surfactant action, which is published in the Surfactant Science Series volume 11, page 109 until 141, edited by E. H. Lucassen-Reynders, it is described that the similar transition points, T1 and T2, are observed for the interaction between SDS and poly-vinyl-pyrrolidone. In the article of D. Muller et al. published in “The Imaging Science Journal”, volume 45 (1997) pages 229-235, he shows similar transition points, T1 and T2, in his study on the interaction of gelatin and sodium dodecyl benzene sulphonate.

According to I. P. Purcell et al., in “Colloids and Surfaces”; A: Physicochemical and Engineering Aspects 94 (1995) pages 125-130, the three different regions in FIG. 3 are generally explained in terms of a polymer-surfactant interaction. Initially, at low surfactant concentrations it is thought that single surfactant ions may be binding to the polymer. On increasing the surfactant concentration the first transition point T1 is reached. This point represents the onset of formation of polymer/surfactant complexes. These complexes are believed to consist of surfactant molecules clustered in sub-units which are themselves absorbed on the polymer. On further addition of the surfactant to the solution more of these polymer-bound micelles are armed until the polymer is saturated at T2. At this point the formation of regular surfactant micelles in the solution commences and the behaviour exhibited is then the same as that of pure surfactant solution.

There are various suitable methods for determining the transition points T1 and T2 mentioned above. Besides the surface tension measurement, one can apply the conductivity measurement, the viscosity measurement, the turbidity measurement and dye absorption spectra measurement.

For the purpose of this invention, “critical aggregation concentration (CAC)” means the first transition point T1, where the complex formation of water-soluble polymer and surfactant aggregates starts.

For the purpose of this invention, “critical micelle concentration (CMC)” means the second transition points T2, where the formation of regular surfactant micelles in the solution starts. The behaviour for the water-soluble polymer/surfactant solution from this point onwards will be the same as that of pure surfactant solution.

It has been discovered by this invention that the concentration of the surfactant in the water-soluble polymer/surfactant solution, should be higher than the CAC value of the surfactant in said solution. The preferred amount of surfactant is between the CAC and the CMC value of the surfactant in the water-soluble polymer/surfactant solution itself. More preferably, the amount of the surfactant is equal to or higher than the CMC value. The value for the CAC as well as for CMC are determined herein by a surface tension measurement method known to those skilled in the art.

The suitable surfactant species can be selected from any surfactant that is classified as cationic surfactants, anionic surfactant, non-ionic surfactants or amphoteric surfactants.

Examples of anionic surfactants are including, but not limited to, the fatty acid surfactants such as the regular soaps, phosphate ester surfactants, sulphate ester surfactant such as sodium dodecylsulphate, sulphated fatty acid surfactants such as sulfated monoglycerides and other polyols, and sulphated alkanolamides, sulphated ethers, sulphated alkylphenol ethoxylates, aliphatic sulfonates such as sodium dodecylsulphonate, alkylaryl sulphonates such as sodium dodecyl benzenesulphonate and α-sulphocarboxylic acids and their derivatives.

Examples of suitable cationic surfactants includes the groups containing alkyl nitrogen compounds such as simple ammonium salts containing at least one long chain alkyl group and one or more amine hydrogens, and quartenary ammonium compounds in which all amine hydrogens have been replaced by organic radical substitution, and the groups of cationic surfactants those contain heterocyclic materials characterised by the N-alkylpyridum halides, salts of alkyl-substituted pyridines, morpholinium salts, and imidazolinium derivatives.

The nonionic surfactants include the polyoxy-ethylenes which have the general formula
RX(CH₂CH₂O)ₙH
where a is normally a typical surfactant hydrophobic group, but may also be a polyether such as polyoxypropylene and X is an O, N or another functionality capable of linking the polyoxyethylene chain to the hydrophobe. The “n” represent the average number of the oxyethylene units and should have a value of higher than 5 to impart sufficient water solubility. Another examples of non-ionic surfactants are the derivatives of sugar, derivatives of polyglycerols and other polyols.

The examples of amphoteric surfactants are those categorised as the ampholites such as aminocarboxyclic acids and lecithin, betaines and sulfobetaines.

The selection of the suitable surfactant depends very much on the surface tension of the microporous film itself. In order to have an effective penetration into the pores of the microporous film it is preferred to use a surfactant that has a surface tension value which is equal, more preferably less than the surface tension value of the microporous film. The anionic surfactants including the group of alkylaryl sulphonate such as sodium dodecyl benzene sulphonate, the aliphatic sulfonates such as sodium dodecyl sulphonates and the sulphate ester surfactant such as Aerosil OT have received our preference. The preferred cationic surfactants comprises the groups that contain quartenary ammonium compounds, such as dodecyl trimethyl ammonium chloride.

The amount of water-soluble polymer should preferably be higher than or equal to 0.01 percent weight in order to have significant effect on the increase of the absorption and wettability properties of the treated microporous film. The preferred amount of the water-soluble polymers is preferably equal to or higher than 0.1 weight percent. The viscosity of the solution limits the maximum amount of the water-soluble polymer. It is believed that the viscosity of the solution higher than 50 cP will not effectively penetrate into the pores.

According to this invention, concentration of water-soluble polymer higher than 10 weight percent is usually not favourable since the viscosity of the water-soluble/polymer solution will become too high. However, for some water-soluble polymers which have a low viscosity and/or low gelling point properties such as hydrolysed gelatins and fish gelatins, the maximum concentration may be higher than 10 weight percent.

The water-soluble polymers can be selected from any of the polymers categorised as bio-polymers, synthesis polymers and the mixtures thereof, as long as it is soluble in water. Examples of classes of bio-polymers include protein such as gelatin, casein and other water-soluble protein, dextrin, and starch. The suitable gelatins are in fact those produced from, among others, the bones and skins of animal through the acid or lime treatment, and also those which are modified afterwards through a chemical reaction, enzymatic treatment or heat treatment. Examples of the suitable gelatins are included acid treated pig skin gelatins, acid treated ossein gelatins, lime treated ossein gelatins, fish skin gelatins, chemically modified gelatins such as modified gelatins with phthalate group, modified gelatins with quartenary ammonium derivatives, modified gelatins with succinyl and dodecenyl succinyl groups, modified gelatin with carbamyl groups, modified gelatin with lauryl groups, modified gelatins with vinyl alcohol groups, modified gelatins with vinyl pyrrolidone, modified gelatins with styrene sulphonate, hydrolysed gelatins and recombinant gelatins. Other examples of the suitable bio-polymers are including starch and starch derivates such as cationic starch, amphoteric starch, oxidized starch, and gum arabic.

There is a lot of variation in the molecular weight of the bio-polymers. An acid or lime bone gelatin for example, has a typical molecular weight in the range of 100 kD to 180 kD. By hydrolysis process, the molecular weight of the lime bone gelatin can be reduced to around 23 kD or even lower when a multiple hydrolysis process is applied to the gelatin. A higher molecular weight gelatin on the other hand, can be produced by a chemical modification of the gelatin itself. According to this invention, the interaction between the water-soluble polymer and the surfactant plays a significant roll. It is believed that a polymer molecule having average molecular weight higher than 200 kD is not suitable for this invention, since the molecules may not efficiently penetrates into the pores. On the other hand, molecular weight of smaller than 1 kD will provide to less interaction with the surfactant molecules. The preferred molecular weight for the bio-polymer is thus between 1 kD and 200 kD, more preferably between 5 kD and 50 kD.

Examples of synthetic water-soluble polymers are polyvinyl alcohol, carboxylated polyvinyl alcohol, cellulose derivatives such as polyacryl-amide-hydroxy alkylcellulose, carboxymethylcellulose and hydroxyethylcellulose, hydroxypolyvinyl pyrrolidone, sodium polyacrylate, polyacrylamide, polyamideepichlorohydrin resin, sodium alginate, alkalinically soluble copolymers of styrene and maleic acid anhydride, polyaminoamide resins, polyethyleneoxid, polyethylene imine, quartenary ammoniumsalt polymers, NBR latex, and polyethylene oxide (PEO).

The preferred average molecular weight of the synthetic polymers is in the range of 14 kD to 200 kD.

Depending on the surfactant and the iso-electric point (IEP) of the (bio)-polymer, the suitable pH of the aqueous solution can be determined. The IEP of the (bio)-polymers lies preferably between pH 3.5 and 12.

In order to further improve the wettability and/or the absorption properties as well as the appearance of the microporous film such as whiteness and glossiness, some appropriate additives thereto may be added into the pre-treatment aqueous solution.

For improving the wettability and/or absortivity it is preferably to add hydrophilic particles selected from the non porous colloidal silicious particles, aluminum oxide, calcium carbonate or the mixture thereof. The non-limiting examples of silicious particles are: silica, mica, montmoriillonite, kaolinite, zeolites and aluminum polysilica. Besides the non-poros colloidal particles, the porous particles such as boehmite, pseudo-boehmite, precipitated silica, silica gel, fumed silica or mixture thereof, are also effective for increasing the absorption speed of the ink solvent. The size of the non-porous colloidal particles should be lower than 700 nanometers in order to avoid blocking of the pores of microporous film. The preferred range for the particle size is in between 5 to 100 nm and more preferably between 10 and 70 nm.

For the porous particles, the size of the particles may be somewhat larger than the non-porous colloidal particles since these particles have the ability to absorb the ink solvent. Particle size between 100 to 2000 nm is suitable to be used herein. The suitable pore size of the porous particles should be in the range of 1 and 500 nm.

The maximum amount of the particles in the water-soluble polymer/surfactant is mainly determined by the final viscosity of the solution. Depending on the charges of the water-soluble polymer, the surfactant and the particles, some degree of interaction between those three components may be expected. This interaction may result in a high solution viscosity, which is not favourable for this invention. Additive particles' amount higher than 50 weight percent of the aqueous solution is thought to be not practical. The suitable amount should be lower than 45 weight percent. The preferred amount for the particles is lower than 35 weight percent and it is more preferable to have a concentration in the range of 1 and 30 weight percent.

The thermoplastic polymers suitable for manufacturing the microporous film are available in a huge number and kinds. In general, any substantially water-insoluble thermoplastic polymers, that can be extruded, calandered, pressed or rolled into film, sheet, strip or web may be used.

The polymer resin is stretched after production. This can be done in the conventional way. The stretching may be monoaxially or biaxially. Generally the degree of stretching is such that it the required pore volume is obtained.

The polymer may be a single polymer or a mixture of polymers. The polymers may be homopolymers, copolymers, random polymers, block copolymers, atactic polymers, isotactic polymers, syndiotactic polymers, linear polymers, or branched polymers. When mixtures of polymers are used, the mixtures may be homogeneous, or it may comprise two or more polymeric phases. Examples of classes of suitable thermoplastic polymers include the polyolefins, poly(halo-substituted polyolefins), polyesters, polyamides, polyurethans, polyureas, polystyrene, poly(vinyl-halides), poly (vinylidene halides), polystyrenes, poly(vinyl esters), polycarbonates, polyethers, polysulfides, polyimides, polysilanes, polysiloxanes, polycaprolactames, polyacrylates, and polymethacrylates. Examples of suitable thermoplastic polymers include high density polyethylene, low density polyethylene, ultra high molecular weight polyethylene, polypropylene (atactic, isotactic or syndiotic), poly(vinyl chloride), polytetrafluroethylene, copolymers of ethylene and alpha-olefines, copolymers of ethylene and acrylic acids, copolymers of ethylene and methacrylic acids, copolymers of ethylene and vinyl acetate, copolymers of propylene and alpha-olefines, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid), poly(-methyl methacrylate), poly(hexamethylene adipamide), poly(epsilon-caprolactam).

The preferred thermoplastics are polyolefin comprising polyethylene, polypropylene, co-polymers of ethylene and alpha-olefines, co-polymers vinyl ethylene-acetate, methyl ethylene-acrylate, ethyl ethylene-acrylate, acrylic ethylene-acid and the ionomers, and the mixture thereof.

The fillers can be selected either from the groups of organic fillers and inorganic fillers. The examples of organic fillers include wood particles, pulp particles, cellulose type particles, polymer particles such as Teflon™ particles and Kevlar™ particles, nylon particles dispersed in polypropylene, polybutylene terephthalate particles in polypropylene, and polypropylene dispersed in polyethylene terephthalate. The important characteristics of these organic fillers are it size and the shape of the particles. Spheres are preferred and they can be hollow or solid.

Examples of the inorganic fillers are included the groups consisting of calcium carbonate, clay, silica, titanium dioxide, talc, clay, kaoline, magnesium sulphate, barium sulphate, calcium sulphate, aluminum hydroxide, magnesium hydroxide, calcium hydroxide, magnesium oxide, zinc oxide, zeolite. The preferred filler is calcium carbonate, silica barium sulphate, titanium dioxide or mixture thereof, having particle sizes lower than 40 μm, preferably in the range of 0.5 and 10 μm.

The amount of filler added to the polyolefin depends on the desired properties of the microporous film including tear strength, water vapour transmission rate and stretchability. It is believed that the voids volume created in the microporous film can not be reached sufficiently for the invention mentioned herein with an amount of filler less than about 80 percent by weight. The more we are able to increase the filler loading amount, the more suitable the film will be due to the increase of the void volume. In order to obtain a filler loading higher than 80 weight percent in the polymer, it may be necessary to coat the inorganic filler with fatty acids such as fatty acid ester, silicone oil or silanes.

In this invention, the microporous film is adhered on a support 14 through an adhesive layer 13, as it is illustrated in FIG. 1. As it is mentioned previously pre-treatment solution can be applied either before or after lamination process of the microporous film. The adhesive layer 13, can be of any materials that have a good properties for adhering the microporous film 11 on the support 14. Examples of such materials are included polyolefin such as polyethylen and polypropylene, polyesthers, polyamide, starch, gelatin, gums arabic, pectin, albumin and agar-agar. More preferable materials for the adhesive layer 13 are those which are permeable to various gas, especially to air and water vapour. The examples of the preferred materials for the adhesive layer is included starch, gelatin, pectin, gum arabic, albumin and agar-agar.

The support 14 is preferably coated on the back side with a polymer matrix comprises of at least a polyolefin resin and an antistatic agent. This back coating is illustrated in FIG. 1 as the layer 15. Furthermore, the support is selected from a photographic base paper, a synthetic paper or a plastic film.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephtalate, polyethylene-2 and 6-naphtalate and polycarbonate, and cellulose acetates such as cellulose triacetate and cellulose diacetate.

The ink receiving layer 12 is characterized by the hygroscopic properties of said layer and its high ability to fix the image with a precise dot size and to provide good image stability. The said ink receiving layer comprises binders, fine porous pigments particles selected from the groups of aluminum oxides such as boehmite and pseudo-boehmite and those of silica such as silica gel and precipitated silica, and optionally various known additives, including surfactants, dye-fixing agent, mordant, etc. Optionally the ink receiving layer 12 may comprise other materials to improve the whiteness and the glossiness appearances of the ink jet medium 10. As the binder, it is usually possible to employ an organic material such as gelatin or one of its modified products, poly (vinyl alcohol), NBR latex, cellulose derivatives, quartenary ammonium salt polymers poly vinyl pyrrolidone or other suitable binders.

In order to further improve the gloss appearance and other additional properties, we may coat an over-coating layer 26, as illustrated in FIG. 2, on top of the ink receiving layer. This layer may comprise cellulose derivatives such as hydroxymethyl cellulose and hydroxyethyl cellulose, poly-vinyl alcohol or gelatin in combination with a suitable cross-linking agent. The over coating layer is non-porous but is ink permeable.

### EXAMPLES

The present invention will be explained in detail by the following non-limiting examples.

### Example 1

The aqueous impregnation solution is prepared by solving 1 weight percent of a hydrolysed lime bone gelatin (GEL-1) having an iso-electric point around pH 5.2, average MW around 23 KD, in water by swelling the gelatin particles for 15 minutes and dissolving the swollen gelatin at temperature of 40° C. The solution is then coated on an ACE microporous film type 949, purchased from ACE S.A. (Belgium), by using a RK grooved bar coater #2. The ACE film is attached to a normal copying paper prior to coating. The coated solution is dried at room temperature and thereafter the contact angle as well as the absorption speed of 1 μl water drop on the pre-treated ACE film, by using the VCA contact angle apparatus made by AST Product, Inc. (USA). The Software of the VCA, VCA 2500, records the changes of the contact angle as well as the volume of the drop for 10 seconds with a recording speed of 4 images per seconds. The absorbed volume as function of time is then calculated by simply extracting the initial volume of drops with the remaining volume of the drop. The result of the measurements is given in table 1.

### Example 2

Another aqueous impregnation solution is prepared by solving 2 weight percent of GEL-1 according to the procedure mentioned in example 1. Into the 2 wt. % gelatin solution, some amount of an-ionic surfactant sodium dodecyl benzene sulphonate (SDBS, MW=348.49), obtained from ICN Biochemicals, Inc. (USA), is added into the gelatin solution in such away that the final solution is containing 1 wt % GEL-1 solution and 1 mmol/L SDBS.

This aqueous solution is then coated on the ACE film type 949 according to the procedure mentioned in example 1. After drying, the contact angle as well as the absorption speed of 1 μl water drop on the pre-treated ACE film are measured, using the VCA contact angle apparatus. The result of the measurements is given in table 1.

### Example 3

The ACE 949 film is impregnated with an aqueous solution containing 1 wt % GEL-1 and 50 mmol/L SBDS as in example 2. The result of the contact angle and absorption speed measurement is given in table 1.

### Comparative Example 1

The contact angle of 1 μl water drop as well as the absorption speed of 1 μl water drop on the untreated ACE film are measured by the method described in example 1.

TABLE 1

| | | | | Absorption |
|---|---|---|---|---|
| | SDBS conc. [mmol/L] in | Contact angle | | speed |
| | 1 wt. % GEL-1 solution | t = 0 s | t = 10 s | [μL/s.] |
| Ex. 1 | 0 (=pure GEL-1 sol.) | 75° | 31° | 0.22 |
| Ex. 2 | 1 | 68° | 39° | 0.30 |
| Ex. 3 | 50 | 48° | 17° | 0.47 |
| Comp. Ex. 1 | untreated ACE film | 108° | 108° | 0.001 |

### Example 4

Into a 100 mmol/L SDBS solution in water, a GEL-2 solution is added in such a way that the a concentration of SDBS and GEL-2 in the solution is respectively 60 mmol/L and 1 wt % A. The temperature of the solution is kept at 40° C. The gelatin GEL-2 is a lime bone gelatin having an IEP around pH 5.0 and MW around 160 KD.

The ACE 949 film is then impregnated with this solution according to example 1. The contact angle and absorption speed of the treated ACE film towards water drops is measured according to the method mentioned in example 1, and the results are given in table 2.

### Example 5

The experiment 7 is repeated by using GEL-3 solution in stead of GEL-2. The GEL-3 is a phthalated lime bone gelatin having an IEP around pH 3.8 and having average MW around 180 HD. The result of the contact angle and absorption speed measurement can be found in table 2.

### Example 6

The experiment 7 is repeated by using GEL-4 solution in stead of GEL-2. GEL-4 is an acid pigskin gelatin having an IEP around pH 9.0 and having average MW around 130 RD. The results of the contact angle and absorption speed measurement can be found in table 2.

### Example 7

The experiment 7 is repeated by using polyvinyl alcohol (PVA) solution in stead of GEL-2 at room temperature. The PVA is the Mowiol 23-88, purchased from Clariant GmbH Frankfurt, Germany. The hydrolyses grade of the PVA is 87.7 mol %. The results of the contact angle and absorption speed measurement can be found in table 2.

### Example 8

The experiment 7 is repeated by using GEL-1 solution. For this experiment, 50 mmol/L dodecyl trimethyl ammonium chloride (DTMAC) is used as surfactant in stead of SDBS. The DTMAC solution of 50 weight percent, is obtained from ICN Biomedicals Inc. The results of the contact angle and absorption speed measurement can be fund in table 2.

### Example 9

The same experiment as ex. 8 is prepared for GEL-4 solution. Next to the DTMAC, a 50 wt % Sylojet® A200 solution is added into the gelatin solution. The Sylojet® A200 solution contained about 20 wt % Al₂O₃ and is purchased from Grace Davidson Inc, (USA). The results of the contact angle and absorption speed measurement can be found in table 2.

TABLE 2

| | Water-soluble polymer. | | | |
|---|---|---|---|---|
| | [1 wt. %] | Contact angle | | Absorption speed |
| | in 50 mmol/L SDBS | t = 0 s | t = 10 s | [μL/s.] |
| Ex. 4 | GEL-2 | 49° | 21° | 0.65 |
| Ex. 5 | GEL-3 | 51° | 26° | 0.79 |
| Ex. 6 | GEL-4 | 45° | 19° | 0.71 |
| Ex. 7 | Mowiol 23-88 | 55° | | 0.50 |
| Ex. 8 | GEL-1 + 50 mmol/L | 47° | 19° | 0.98 |
| | DTMAC | | | |
| Ex. 9 | GEL-4 + 50 mmol/L | 27° | 19° | 1.46 |
| | DTMAC + A200 | | | |

### Example 10

Another set of experiments was done, analyzing the effect of impregnation solution on the drying speed of the ink jet media. An ACE microporous films is adhered onto a 166 gr/m² paper base by means of an adhesive layer containing phtalated lime bone gelatin (GEL-3) and silica gel (Sylojet 703 A, from Grace Davidson, USA). The dry solid content ratio between the GET-3 and Silica gel is 1 to 2. The surface tension of the ACE film is measured by the contact angle method known in the field of art and is amounted 30-38 dyne/cm.

The impregnation solution is prepared by mixing the solutions of 2 wt % GEL-5 with 2 wt % Aerosol OT (Nippon Yushi, Japan) and de-ionized water in such away that the final concentration of the GEL-5 and Aerosol OT is respectively 1 wt % and 0.8 wt %. The gelatin GEL-5 is a hydrolyzed lime gelatin having an IEP around pH 5.2 and MW around 1.5 to 2 KD. The surface tension of 1 wt % Aerosol OT in water is 25 dyne/cm.

The ink receiving solution is prepared by mixing 615 parts of 28.6 wt % of HP-14 sol, 275 parts of 10 wt % of PVA Mowiol 23-88 (purchased from Clariant), and 110 parts of de-ionized water. The HP-14 powder contains alumina hydrate of boehmite structure and is purchased from Sasol, Germany.

Impregnation and Coating the Adhered Microporous Film

The ACE film is treated with the impregnation solution by using a RK grooved bar #3 and dried at room temperature for about 3 hours. Thereafter, the ink receiving solution is coated on the impregnated ACE film by using a RK grooved bar # 5 and dried at 70 C for about 2 hours.

Printing Test:

The microporous ink jet media is further subjected to an ink-jet printing test. A standard pattern comprising the colours magenta, cyan, yellow, green, red, blue and black in 5 different densities is printed on the above mentioned microporous substrates. The printers which were used herein are Epson PM 770C and HP 990.

Directly after printing the standard pattern, a white paper was overlaid on the printed microporous substrate and a stainless steel roller with a weight of 10 kg was rolled over the white paper slowly. The drying speed of the microporous substrate was deterred by analyzing visually the colour density of the print which was transferred to the white paper. A lower density at the white paper means a better drying speed of the ink jet solvent. The results of the printing test can be found in table 3.

### Example 11

The same experiment as mentioned in Example 10 is conducted, except that GEL-6 is used in the impregnation solution in stead of GEL-5. The GEL-6 is a lime bone gelatin having average MW of 160 kD and an IEP around pH 5. The result of the printing test can be found in table 3.

### Comparative Example 2

The same experiment as mentioned in Example 10 is carried out, except that the impregnation solution contains only 1 wt % Aerosol OT. The result of the printing test can be found in table 3.

### Comparative Example 3

The similar experiment as mentioned in Example 10 is carried out. In this test the microporous film is not impregnated. It is directly coated with the said ink receiving layer. The result of the printing test is listed in table 3.

TABLE 3

| | | Drying speed*⁾ | |
|---|---|---|---|
| | | Epson | |
| | Impregnation solution | 770 C | HP990 |
| Ex. 10 | 1 wt. % GEL-5 and 0.8 wt. % Aerosol OT. | ◯ | ◯ |
| | GEL-5: MW = 1.5-2 KD | | |
| | Surface tension 1 wt % Aerosol OT in | | |
| | water at 20 C: 25 dyne/cm | | |
| Ex. 11 | 1 wt. % GEL-6 and 0.8 wt. % Aerosol OT. | Δ | Δ |
| | GEL-6: MW = 160 KD | | |
| Comp. | Only 1 wt % Aerosol OT | X | Δ − X |
| Ex. 2 | | | |
| Comp. | No impregnation | XX | XX |
| Ex. 3 | | | |

*⁾Definitions:
◯ = Good
Δ = Not totally dry but still acceptable
X = Bad (not acceptable)
XX = Very bad and causing serious colour bleeding

From these experiments it can be seen that the formulation of impregnation solution has a significant effect on the drying speed of the print.

1. An ink jet recording medium comprising:
a supports
a water-repellent microporous film adhered to said support, said microporous film being an oriented thermoplastic film comprising fillers and having interconnecting channels between the pores, with a void volume between 30 to 90 volume percent of the total microporous film, wherein said microporous film has been impregnated with an aqueous solution comprising at least a water-soluble polymer and surfactant,
at least one ink receiving layer as a coating on said impregnated microporous film, and optionally,
a protective layer on top of the ink receiving layer.

2. The medium according to claim 1, wherein the thickness of said microporous film is less than 160 micrometers.

3. The medium according to claim 1 or 2, wherein the thickness of said microporous film is between 15 to 100 micrometers.

4. The medium according to claim 1-3, wherein the amount of said water-soluble polymer is at least 0.01 weight percent of the aqueous solution.

5. The medium according to claim 1-4, wherein the amount of surfactant in the aqueous solution is higher than the critical aggregation concentration (CAC) of the surfactant/water-soluble polymer solution itself.

6. The medium according to claim 5, wherein the amount of surfactant in the aqueous solution is between the critical aggregation concentration (CAC) and the critical micelle concentration (CMC) of the surfactant/water-soluble polymer solution itself.

7. The medium according to claim 5, wherein the amount of the surfactant is equal to or higher than the critical micelle concentration (CMC) of the surfactant/water-soluble polymer solution.

8. The medium according to claim 1-7, wherein the viscosity of the aqueous solution during treatment of the microporous film is lower than 50 cP.

9. The medium according to claim 1-8, wherein the water-soluble polymer is chosen from the group of material consisting of gelatin, phthalated gelatin, modified gelatin with ammonium derivatives, modified gelatin with succinyl groups, modified gelatin with vinyl alcohol groups, modified gelatin with vinyl pyrrolidone groups, hydrolised gelatin, polyvinyl alcohol (PVA), polyvinyl pyrrolidone (PVP), polyethylene oxide (PEO), polyacryl amide and polyacrylate.

10. The medium according to claim 9, wherein the water-soluble polymer comprises gelatin, polyvinyl alcohol (PVA), polyvinyl pyrrolidone (PVP), polyethylene oxide (PEO) or mixtures thereof.

11. The medium according to claim 1-10, wherein the water-soluble polymer comprises gelatin with an average molecular weight between 1 kD to 200 kD, or polyvinyl alcohol (EVA), polyvinyl pyrrolidone (PVP), polyethylene oxide (PEO) or mixtures of the synthetic polymers having an average molecular weight between 14 kD and 200 kD

12. The medium according to claim 11, wherein the water-soluble polymer comprises gelatin with an average molecular weight preferably between 1 kD to 50 kD, or polyvinyl alcohol (PVA), polyvinyl pyrrolidone (PVP), polyethylene oxide (PEO) or mixtures of the synthetic polymers having an average molecular weight preferably between 60 kD and 180 kD.

13. The medium according to claim 1-12, wherein the iso-electric point (IEP) of said water-soluble polymer is in the range of pH 3.5 and 12.

14. The medium according to claim 1-13, wherein the surfactant is selected from the group of anionic surfactants, cationic, non-ionic and amphoteric surfactants.

15. The medium according to claim 14, wherein the surfactant is preferably selected from the anionic groups containing alkylaryl sulphonates, sulphate ester and aliphatic sulphonates, and from the cationic surfactants containing quarternary ammonium compounds.

16. The medium according to claim 1-15, wherein the aqueous solution further contains additives in an amount lower than 45 weight percent of the aqueous solution.

17. The medium according to claim 16, wherein the amount of additives is lower than 35 weight percent of the aqueous solution.

18. The medium according to claims 16 or 17, wherein the amount of additives is in the range between 1 and 30 weight percent of the aqueous solution.

19. The medium according to any of the claims 16-18, wherein said additives comprise nonporous colloidal particle selected from the group comprises silicious particles, aluminum oxide and calcium carbonate, or porous particles including boehmite, pseudo-boehmite, precipitated silica gel and famed silica, or the mixture thereof.

20. The medium according to claim 19, wherein the size of said colloidal particles is in the ranges between 5 to 700 nm.

21. The medium according to claim 20, wherein the size of said colloidal particles is in the ranges between 5 to 100 nms.

22. The medium according to claim 21, wherein the size of said colloidal particles is in the ranges between 5 to 70 nm.

23. The medium according to claim 19-22, wherein said additives comprising porous particles having an average particle size in the range between 100 and 2000 nanometers.

24. The medium according to claim 23, wherein the size of the pores of said porous particles are in the range between 1 and 500 nanometers.

25. The medium according to claim 1-24, wherein the manufacturing process of said microporous film comprises mixing of an orientable thermoplastic resin with at least one coated filler, extruding said mixture at elevated temperatures to form a film thereof, pre-stretching the film, cooling said film until the film is solidified and stretching said cooled film to form a microporous film.

26. The medium according to claim 1-25, wherein said microporous film comprises of 30 to 90 weight percent of filler.

27. The medium according to claim 1-26, wherein said filler comprises calcium carbonate, barium sulphate, silica, titanium dioxide or a mixture thereof.

28. The medium according to claim 1-27, wherein said filler has an average particle size less than 40 μm.

29. The medium according to claim 28, wherein said filer has an average particle size preferably between 0.5 μm and 10 μm.

30. The medium according to claim 25-29, wherein the thermoplastic resin comprising polyolefin comprising polyethylene, polypropylene, co-polymers of ethylene and alpha-olefines, co-polymers vinyl ethylene-acetate, methyl ethylene-acrylate, ethyl ethylene-acrylate, acrylic ethylene-acid and the ionomers, or the mixture thereof.

31. The medium according to claim 1-30, wherein said support is a photographic base paper, a synthetic paper or a film substrate.

32. The medium according to claim 1-31, wherein said support is laminated on one side with a polymer matrix comprises at least a polyolefin resin.

33. The medium according to claim 1-32, wherein said ink receiving layer comprises absorbent particles and binder.

34. The medium according to claim 33, wherein said absorbent particles in the ink receiving layer is silica, boehmite, pseudo boehmite or combination thereof.

35. The medium according to claim 33 or 34, wherein said binder in the ink receiving layer comprises gelatins, polyvinyl alcohol, polyvinyl pyrolidone, cellulose derivatives or the mixtures thereof.

36. The medium according to claim 1-35, further comprising an ink-permeable protective layer on top of said ink receiving layer.

37. The medium according to claim 36, wherein said protective layer comprises hydroxypropyl methyl cellulose, polyvinyl alcohol or gelatin solution.

38. Method for preparing an ink jet recording medium comprising the steps of:
a. pre-treating a water-repellent microporous film with an aqueous solution comprising at least a water-soluble polymer and surfactant, said microporous film being an oriented thermoplastic film comprising fillers and having interconnecting channels between the pores, with a void volume between 30 to 90 volume percent of the total microporous film:
b. adhering said film to a support;
c. coating an ink receiving layer on said film; optionally followed by
d. coating a protective layer on top of said ink receiving layer; wherein step a is carried out before step c.

39. Method according to claim 38, wherein step a is carried out before step b.

40. Ink jet recording medium obtainable by the method of claim 38 or 39.

41. A method of forming a permanent, precise ink jet image comprising the step of:
providing an ink jet recording medium according to any one of the claims 1-37 or 40
introducing ink jet ink into contact with the medium in the pattern of a desired image.

42. A hydrophilic and hygroscopic microporous film, which is obtained by impregnating a water repellent film comprising an oriented thermoplastic and at least one filler, which film is permeable to air and water vapour, and has a void volume between 30 and 90 volume percent of the total film, with an aqueous solution comprising at least a water-soluble polymer and surfactant.
